(19) United States
(12) Patent Application Publication
(10) Pub. No.: US 2005/0085933 A1
(43) Pub. Date: Apr. 21, 2005

(54) Digital audio assembly

(76) Inventor: Chi-Liang Lo, Taichung (TW)

Correspondence Address: Lo Chi-Liang, P.O. BOX 2103, Taichung, R.O.C., TW

(21) Appl. No.: 10/687,089

(22) Filed: Oct. 17, 2003

(51) Int. Cl. G06F 17/00

(52) U.S. Cl. 700/94

(57) ABSTRACT

A digital audio assembly includes a digital signal processor (DSP) mounted and a digital analog converter (DAC) mounted therein. A universal serial bus (USB) socket is mounted in a front panel of a base member and electrically connected to the DSP. The USB socket can be connected to extra media. A secure digital memory card (SD card) socket is mounted in the front panel and electrically connected to the DSP. The SD card socket can receive a SD card and read the digital signals in the SD card. A sound-source input port is mounted in the front panel and electrically connected to the DAC, and a sound-effect input/output port is mounted in a rear panel of the base member and electrically connected to the DAC.

### BACKGROUND OF THE INVENTION

1. Field of the Invention

The present invention relates to a digital audio assembly, and more particularly to a digital audio assembly that can play and record the digital signal.

2. Description of Related Art

A conventional digital sound-recording device transforms the sound-source signal into digital signal and saving therein. The conventional digital sound-recording device can play the digital signal or deliver the digital signal to a personal computer (PC) via universal serial bus (USB) and the PC plays the digital signal by a motion picture expert group audio layer 3 (MP3) that is installed in the PC.

The advantages of the conventional digital sound-recording device are having a small volume and easily being carried. However, the recording capacity is decided by the integrated circuit (IC) installed therein such that the volume limits the recording capacity of the conventional sound-recording device. Furthermore, the conventional sound-recording device only plays the digital signal saved therein.

The present invention has arisen to mitigate and/or obviate the disadvantages of the conventional sound-recording device.

### SUMMARY OF THE INVENTION

The main objective of the present invention is to provide an improved digital audio assembly that can play and record the digital signals.

To achieve the objective, the digital audio assembly in accordance with the present invention comprises a digital signal processor (DSP) mounted and a digital analog converter (DAC) mounted therein. A universal serial bus (USB) socket is mounted in a front panel of a base member and electrically connected to the DSP. The USB socket can be connected to extra media. A secure digital memory card (SD card) socket is mounted in the front panel and electrically connected to the DSP. The SD card socket can receive a SD card and read the digital signals in the SD card. A sound-source input port is mounted in the front panel and electrically connected to the DAC, and a sound-effect input/output port is mounted in a rear panel of the base member and electrically connected to the DAC.

Further benefits and advantages of the present invention will become apparent after a careful reading of the detailed description with appropriate reference to the accompanying drawings.

### BRIEF DESCRIPTION OF THE DRAWINGS

FIG. 1 is a front perspective view of a digital audio assembly in accordance with the present invention;

FIG. 2 is a rear perspective view of the digital audio assembly in FIG. 1; and

FIG. 3 is a block diagram illustrating details of the digital audio assembly in FIG. 1.

### DETAILED DESCRIPTION OF THE INVENTION

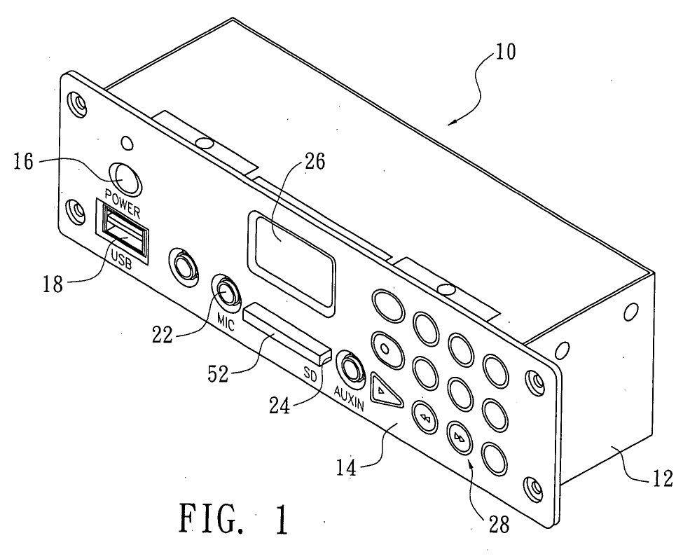

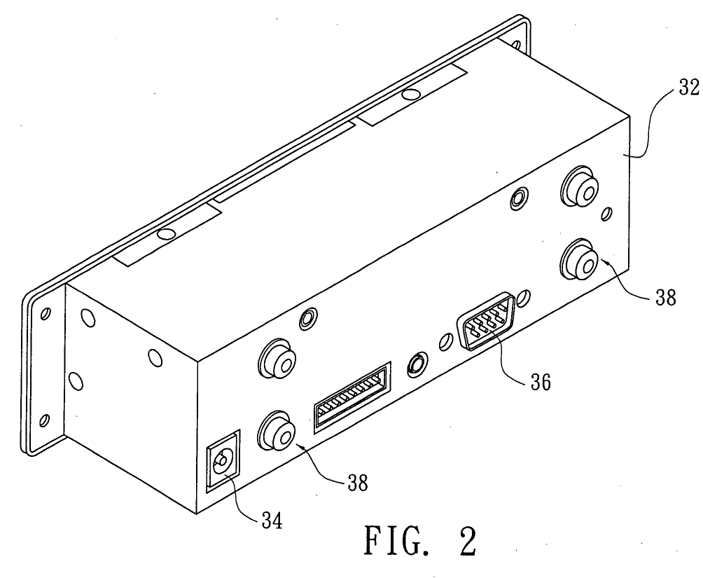

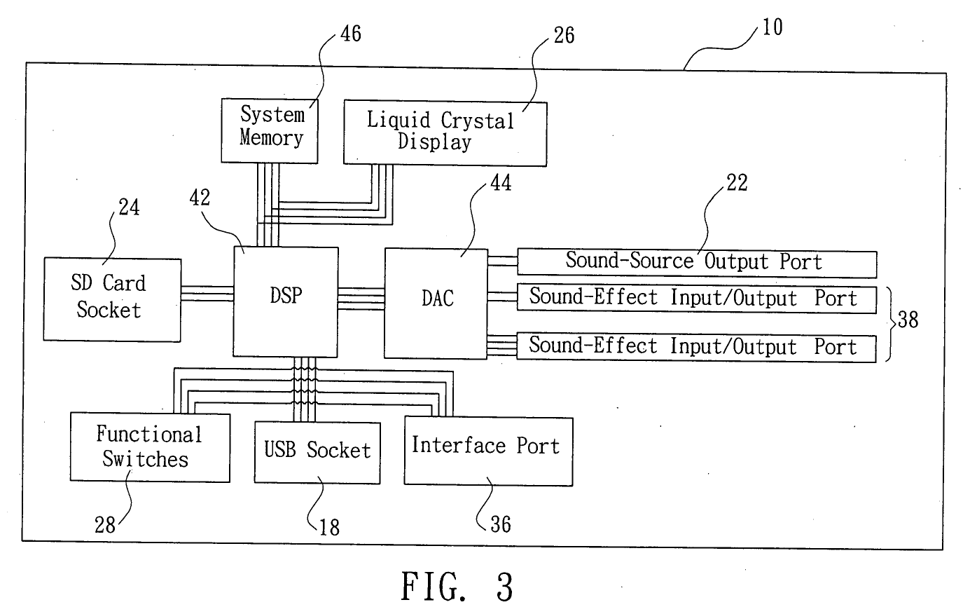

Referring to the drawings and initially to FIGS. 1-3, a digital audio assembly (10) in accordance with the present invention comprises a digital signal processor (DSP, 42), a digital analog converter (DAC, 44) and a system memory (46), wherein the DAC (44) and the system memory (46) are respectively electrically connected to the DSP (42).

The digital audio assembly (10) base member (12) having a front panel (14) and rear panel (32) opposite to the front panel (14) of the base member (21). The digital audio assembly (10) includes a power switch (16), a USB socket (18), a secure digital memory card (SD card) socket (24), a liquid crystal display (26) and multiple functional switches (28) respectively mounted in the front panel (14) and electrically connected to the DSP (42). A sound-source input port (22) is mounted in the front panel (14) and electrically connected to the DAC (44).

A SD card (52) is inserted into the SD card socket (24) such that the digital audio assembly (10) of the present invention can read and play the digital signals that are saved in the SD card (52). The USB socket (18) can be connected to extra media and the digital audio assembly of the present invention can read the digital signals in the extra media via the USB connection.

A direct current (DC) socket (34), an interface port (36) and a sound-effect input/output port (38) are mounted in the rear panel (32). The DC socket (34) is adapted to be connected to a power source for providing electric power to the present invention. The interface port (36) is electrically connected to the DSP (42) and can be electrically connected to a PC such that the user can control the digital audio assembly via the PC. Furthermore, the digital audio assembly (10) of the present invention can read the digital signals from the extra media via the USB connection and transmit the digital signals from the extra media to the PC via the interface port (36) such that PC can save the digital signals in the PC. The sound-effect input/output port (38) is electrically connected to the DAC (44).

Although the invention has been explained in relation to its preferred embodiment, it is to be understood that many other possible modifications and variations can be made without departing from the spirit and scope of the invention as hereinafter claimed.

1. A digital audio assembly comprising:
a digital signal processor (DSP) mounted in the digital audio assembly;
a digital analog converter (DAC) mounted in the digital audio assembly;
a base member including a front panel and a rear panel opposite to the front panel;
a universal serial bus (USB) socket mounted in the front panel and electrically connected to the DSP, the USB socket can be adapted to be connected to extra media and the digital audio assembly reading the digital signals in the extra media via the USB connection;
a secure digital memory card (SD card) socket mounted in the front panel and electrically connected to the DSP, the SD card socket adapted to receive a SD card such that the digital audio assembly of the present invention can read and play the digital signals that are saved in the SD card;
a liquid crystal display mounted in the front panel and electrically connected to the DSP;
multiple functional switches respectively mounted in the front panel and electrically connected to the DSP for user to control the digital audio assembly;
a sound-source input port mounted in the front panel and electrically connected to the DAC; and
a sound-effect input/output port mounted in the rear panel and electrically connected to the DAC.

2. The digital audio assembly as claimed in claim 1 further comprising an interface port electrically connected to the DSP and adapted to be electrically connected to a PC such that the user can control the digital audio assembly via the PC, thereby the digital audio, assembly reads the digital signals from the extra media via the USB connection and transmits the digital signals from the extra media to the PC via the interface port such that PC can save the digital signals therein.
